(19) United States
(12) Patent Application Publication
(10) Pub. No.: US 2025/0303877 A1
(43) Pub. Date: Oct. 2, 2025

(54) SOLAR CHARGING SYSTEM

(71) Applicant: TOYOTA JIDOSHA KABUSHIKI KAISHA, Toyota-shi (JP)

(72) Inventor: Yukinori Murakami, Toyota-shi (JP)

(73) Assignee: TOYOTA JIDOSHA KABUSHIKI KAISHA, Toyota-shi (JP)

(21) Appl. No.: 19/001,441

(22) Filed: Dec. 25, 2024

(30) Foreign Application Priority Data
Mar. 27, 2024 (JP) 2024-051582

(51) Int. Cl. B60L 8/00; B60L 53/51; H02J 7/00

(52) U.S. Cl. CPC B60L 8/003; B60L 53/51; H02J 7/00047; H02J 7/00712; H02J 7/007194; H02J 2300/26

(57) ABSTRACT

A solar charging system comprising a solar panel, an auxiliary battery charged by power generated by a solar panel, a main battery different from the auxiliary battery, and a control unit provided between the auxiliary battery and the main battery and controlling charging of the main battery by the generated power, wherein when the acceptable charge amount of the auxiliary battery is limited, the control unit controls the generated power to a state in which the main battery can be charged if the chargeable amount of the main battery is larger than the chargeable amount of the auxiliary battery.

### CROSS-REFERENCE TO RELATED APPLICATION

This application claims priority to Japanese Patent Application No. 2024-051582 filed on Mar. 27, 2024, incorporated herein by reference in its entirety.

### BACKGROUND

### 1. Technical Field

The present disclosure relates to a solar charging system that controls charging of a battery using power generated by a solar panel.

### 2. Description of Related Art

Japanese Unexamined Patent Application Publication No. 2021-083248 (JP 2021-083248 A) discloses a solar charging system that derives power that a solar panel actually generates by supplying power to an auxiliary system including an auxiliary battery from the solar panel in a case where the solar panel is in a state where power can be generated. If the thus derived actually generated power is equal to or greater than a prescribed value, the solar charging system further charges a main battery with the power generated by the solar panel.

### SUMMARY

Since the amount of charging that an auxiliary battery can receive changes depending on its state (such as a power accumulation rate and a temperature), the amount of charging is limited in some cases from the viewpoint of protecting the battery. However, the solar charging system disclosed in JP 2021-083248 A described above does not perform control to switch a target to be charged with the power generated by the solar panel depending on the amount of charging that the auxiliary battery can receive. Therefore, it may be difficult to efficiently use the power generated by the solar panel in a case where the amount of charging that the auxiliary battery can receive is limited.

Therefore, there is room for further consideration of a method of charging the auxiliary battery performed by the solar charging system including a case where the amount of charging that the auxiliary battery can receive is limited.

The present disclosure provides a solar charging system capable of efficiently controlling charging using power generated by a solar panel in a case where the amount of charging that an auxiliary battery can receive is limited.

A solar charging system according to an aspect of the technology of the present disclosure includes:
a solar panel;
an auxiliary battery (first battery) that is charged with power generated by the solar panel; a main battery (second battery) that is different from the auxiliary battery; and
a control unit that is provided between the auxiliary battery and the main battery and controls charging of the main battery with the generated power,
and in a case where the amount of charging that the auxiliary battery is able to receive is limited, and if the amount of charging by which the main battery is able to be charged is greater than the amount of charging by which the auxiliary battery is able to be charged, the control unit performs control to achieve a state where the main battery is able to be charged with the generated power.

The solar charging system according to the present disclosure determines a battery with a large amount of charging by which the battery can be charged as a target to be charged in a case where the amount of charging that the auxiliary battery can receive is limited, and can thus efficiently control charging using power generated by the solar panel.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a solar charging system and a peripheral portion thereof according to an embodiment of the present disclosure;

FIG. 2 is a processing flowchart of a battery charging control executed by the solar charging system;

FIG. 3 is a detailed process flow chart of S203 of FIG. 2;

FIG. 4 is a detailed process flow chart of S204 of FIG. 2; and

FIG. 5 is an image diagram illustrating a selection example of a battery charging mode.

### DETAILED DESCRIPTION OF EMBODIMENTS

The solar charging system according to the present disclosure determines whether it is more efficient to charge the generated power of the solar panel to the auxiliary battery or to charge the main battery based on the chargeable amount of the auxiliary battery and the main battery when the acceptable charge amount of the auxiliary battery is limited. Hereinafter, an embodiment of the present disclosure will be described in detail with reference to the drawings.

### Embodiment

### Configuration

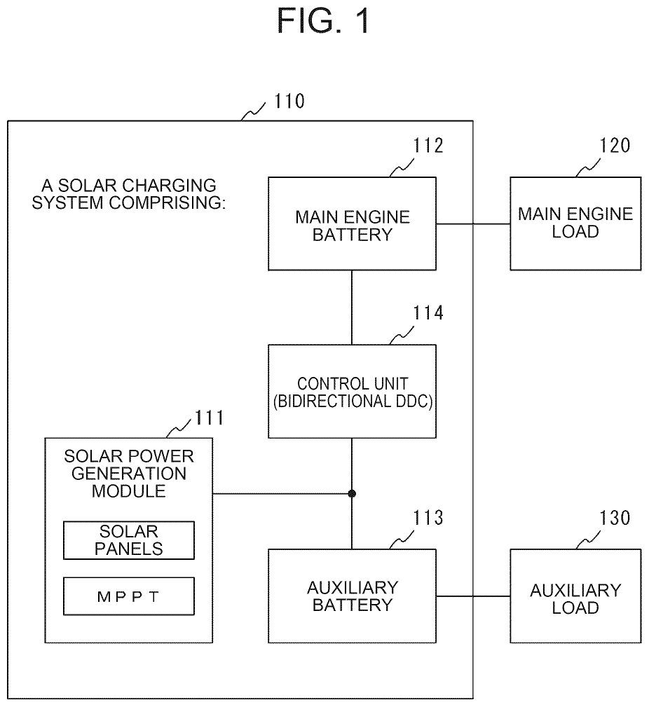

FIG. 1 is a block diagram illustrating a schematic configuration of a solar charging system 110 and a peripheral portion thereof according to an embodiment of the present disclosure. The solar charging system 110 illustrated in FIG. 1 includes a solar power generation module 111, a main battery 112, an auxiliary battery 113, and a control unit 114. In addition, the solar charging system 110 is connected to the main machine load 120 and the auxiliary machine load 130 so as to be able to supply electric power.

The solar charging system 110 may be mounted on vehicles such as hybrid electric vehicle (HEV), plug-in hybrid electric vehicle (PHEV), and battery electric vehicle (BEV), for example. Hereinafter, a case where the solar charging system 110 is mounted on a vehicle will be described.

The solar power generation module 111 is a power generation device that generates electric power by being irradiated with sunlight, and outputs the generated electric power to an auxiliary battery 113 connected to the solar power generation module 111, an auxiliary machine load 130 connected to the auxiliary battery 113, and the like. The solar power generation module 111 includes a solar panel that is an aggregate of solar cells, an MPPT control unit (MPPT) that realizes a maximum power point of power generation in the solar panel by follow-up control, and the like. The generated electric power of the solar panel is calculated from measured values of various sensors (not shown) and the like.

The main battery 112 (second battery) is a secondary battery configured to be chargeable and dischargeable, such as a lithium-ion battery. The main battery 112 is connected to a main machine load 120 included in the main engine system, and can supply electric power necessary for the operation of the main machine load 120. The main battery 112 is chargeable by the power generated by the solar panel, and is connected to the solar power generation module 111 via the control unit 114. The main battery 112 is connected to the auxiliary battery 113 via the control unit 114 so that the electric power stored by itself can be supplied to the auxiliary battery 113 and can be charged by the electric power stored in the auxiliary battery 113. The main battery 112 is, for example, a driving battery having a rated voltage higher than that of the auxiliary battery 113.

The auxiliary battery 113 (first battery) is a secondary battery configured to be chargeable and dischargeable, such as a lithium-ion battery or a lead-acid battery. The auxiliary battery 113 is connected to an auxiliary machine load 130 included in the auxiliary machine system, and can supply electric power necessary for the operation of the auxiliary machine load 130. In addition, the auxiliary battery 113 can supply power for driving to a system necessary for controlling the charging of the generated power of the solar panel. The auxiliary battery 113 is connected to the solar power generation module 111 so that it can be charged by the power generated by the solar panel. Further, the auxiliary battery 113 is connected to the main battery 112 via the control unit 114 so as to be able to be charged by the electric power stored in the main battery 112 and to be able to supply the electric power stored by itself to the main battery 112. The power storage rate, the temperature, and the like of the auxiliary battery 113 are monitored by various sensors (not shown).

The control unit 114 is a bidirectional power converter capable of converting input power into power of a predetermined voltage and outputting the converted power, and is typically configured as an electronic control unit including a bidirectional DCDC converter (bidirectional DDC). The control unit 114 has one end (primary side) connected to the solar power generation module 111 and the auxiliary battery 1130, and the other end (secondary side) connected to the main battery 1120. The control unit 114 may supply (pump-charge) electric power output from the solar power generation module 111 and the auxiliary battery 113 connected to one end to the main battery 1120 connected to the other end. At the time of the power supply, the control unit 114 performs a boosting operation of boosting the voltage of the auxiliary battery 113 input to one end to become the output voltage of the other end. In addition, the control unit 114 can supply (pump-out charge) the electric power of the main battery 112 connected to the other end to the auxiliary battery 113 connected to the one end. At the time of power supply, the control unit 114 performs a step-down operation in which the voltage of the main battery 112 input to the other end is stepped down to be the output voltage of the one end.

In addition, the control unit 114 can acquire the generated power of the solar panel in the solar power generation module 111, the state (storage rate, temperature, and the like) of the main battery 112, and the state (storage rate, temperature, and the like) of the auxiliary battery 113. Further, the control unit 114 can determine whether the acceptable charge amount of the main battery 112 is limited, and whether the acceptable charge amount of the auxiliary battery 113 is limited. The control executed by the control unit 114 will be described later.

The main machine load 120 is various main engine devices mounted on the vehicle. The main machine load 120 is operated by using the main battery 112 as a power source and receiving the supply of electric power stored in the main battery 112. Examples of the main machine load 120 include an electric motor for traveling.

The auxiliary machine load 130 is a variety of auxiliary devices mounted on the vehicle. The auxiliary machine load 130 is operated by using the solar power generation module 111 and the auxiliary battery 113 as a power source and receiving the power generated by the solar panel and the power stored in the auxiliary battery 113. Examples of the auxiliary machine load 130 include lighting devices such as headlamps and indoor lamps, air conditioners such as heaters and air conditioners, and systems for autonomous driving and advanced driving support.

### Control

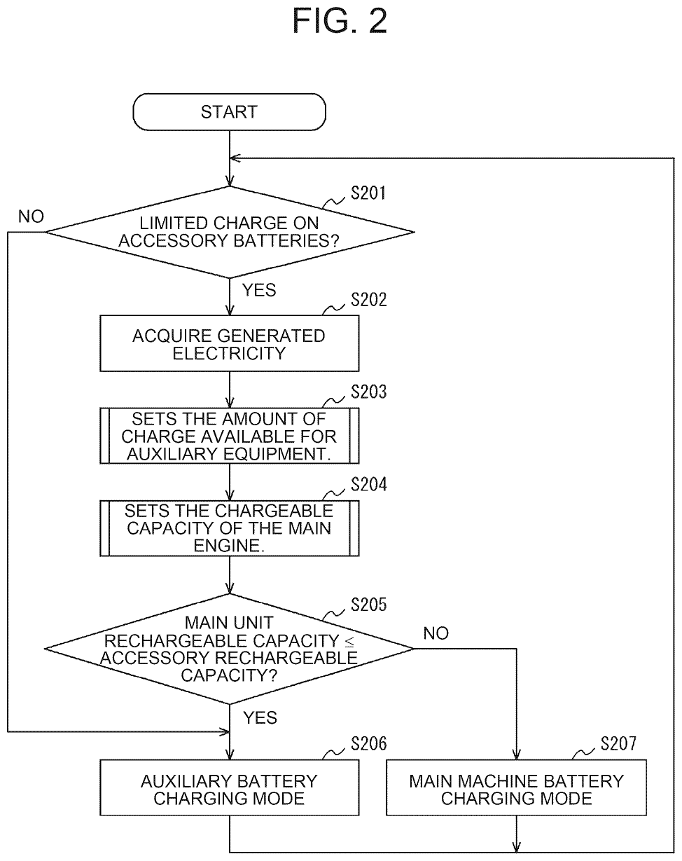

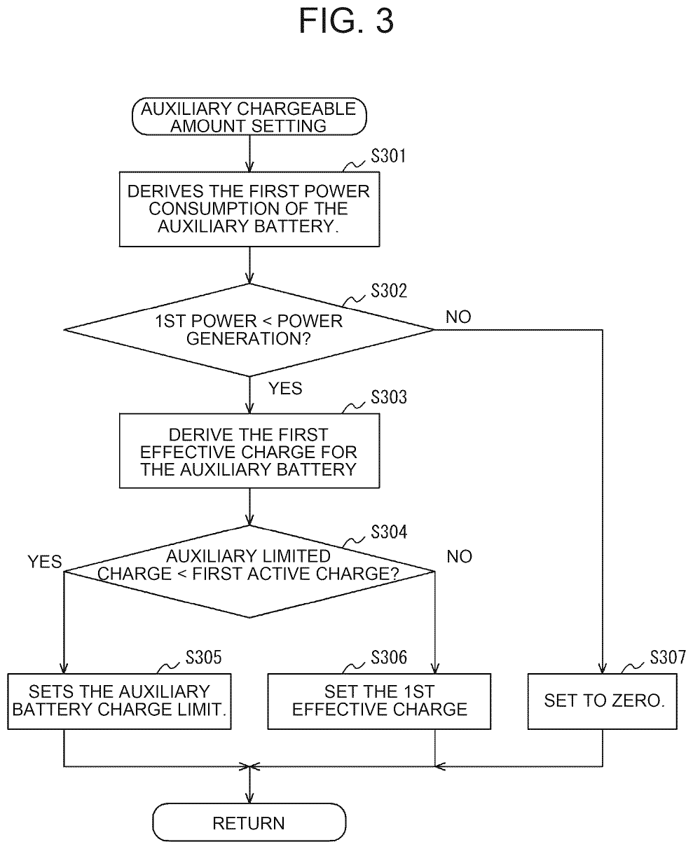

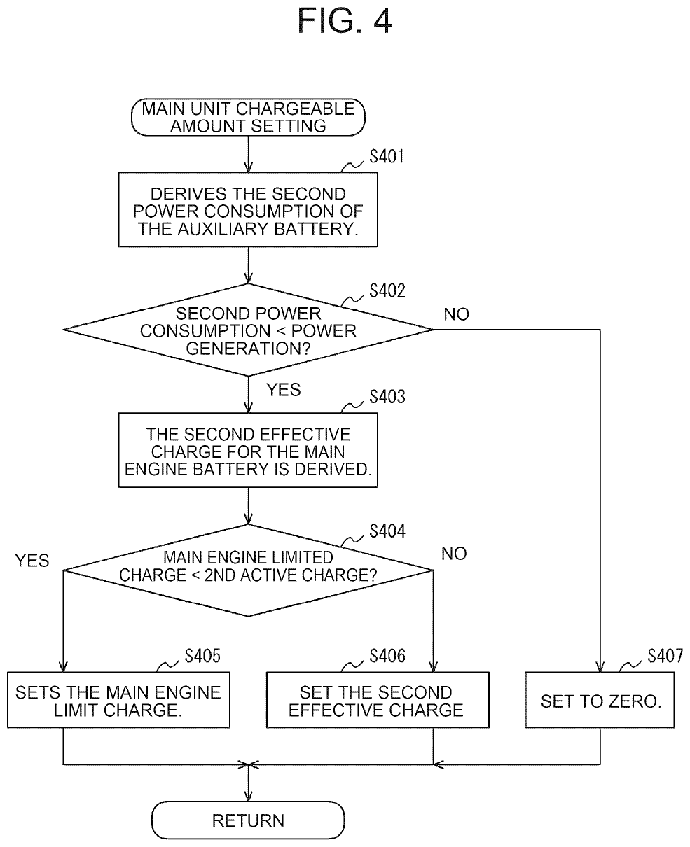

Next, the control performed by the solar charging system 110 according to the present embodiment will be described with further reference to FIGS. 2, 3, and 4. FIG. 2 is a flowchart (main routine) for explaining a processing procedure of the battery charging control executed by the control unit 114 of the solar charging system 110. FIG. 3 is a flow chart (sub-routine) illustrating a detailed process of setting an auxiliary chargeable capacity according to S203 of FIG. 2. FIG. 4 is a flow chart (sub-routine) illustrating a detailed process of setting the chargeable capacity of the main machine according to S204 of FIG. 2.

The battery charging control illustrated in FIGS. 2, 3, and 4 is started, for example, when the solar panel of the solar power generation module 111 generates power exceeding a predetermined power, and is repeatedly performed until the generated power of the solar panel becomes equal to or less than the predetermined power.

### A: Main Routine (FIG. 2)

### S201

The control unit 114 determines whether or not the acceptable charge amount of the auxiliary battery 113 is limited. The charge amount is limited, for example, when the power storage rate (SOC) of the auxiliary battery 113 is equal to or higher than a predetermined power storage rate or when the temperature of the auxiliary battery 113 is equal to or higher than a predetermined temperature. The control unit 114 can determine that the auxiliary battery 113 is limited based on state information of a specific component or the like. The limited charge amount is appropriately determined in accordance with the full charge capacity of the auxiliary battery 113, the performance and specifications of the vehicle, and the like. If the auxiliary battery 113 is limited in charge (S201, Yes), the process proceeds to S202. On the other hand, if the auxiliary battery 113 is not limited to the charge level (S201, No), the process proceeds to S206.

### S202

The control unit 114 acquires, from the solar power generation module 111, information related to the electric power currently generated by the solar panel receiving solar radiation. When the generated electric power of the solar panel is acquired, the process proceeds to S203.

### S203

The control unit 114 sets a charging amount that the auxiliary battery 113 can charge (hereinafter, referred to as “auxiliary chargeable amount”). A method of setting the auxiliary chargeable amount will be described later with reference to FIG. 3. When the auxiliary chargeable capacity is set, the process proceeds to S204.

### S204

The control unit 114 sets a charging amount that the main battery 112 can charge (hereinafter referred to as “main machine chargeable amount”). The method of setting the main chargeable amount will be described later with reference to FIG. 4. When the chargeable capacity of the main engine is set, the process proceeds to S205.

### S205

The control unit 114 compares the auxiliary chargeable amount with the main chargeable amount, and determines whether or not the auxiliary chargeable amount is equal to or greater than the main chargeable amount. If the auxiliary chargeable amount is equal to or greater than the main chargeable amount (S205, Yes), the process proceeds to S206. On the other hand, if the auxiliary chargeable amount is less than the main chargeable amount (S205, No), the process proceeds to S207.

### S206

The control unit 114 selects (switches) the “auxiliary battery charging mode” in which the auxiliary battery 113 (auxiliary system) is charged by the generated electric power of the solar panel in the charging control of the solar charging system 110, and performs solar charging. When the charge mode to be controlled is selected, the process proceeds to S201.

### S207

The control unit 114 selects (switches) the “main battery charging mode” in which the main battery 112 (main machine system) is charged by the generated electric power of the solar panel to control charging of the solar charging system 110, and performs solar charging. When the charge mode to be controlled is selected, the process proceeds to S201.

When the auxiliary device chargeable amount and the main device chargeable amount are the same, the efficiency of solar charging does not change even if either the auxiliary battery charging mode or the main device battery charging mode is performed. Therefore, in the above S205, it may be determined whether or not the auxiliary chargeable amount is larger than the main chargeable amount. That is, when the determination of S205 is equal (=), the main battery charge mode (S207) may be selected.

### B: Subroutine (FIG. 3)

### S301

The control unit 114 derives the first power consumption related to the auxiliary battery 113. The first power consumption is the power consumed by the auxiliary battery 113 based on the driving of the system necessary for charging the auxiliary battery 113 with the generated power of the solar panel. The required configuration includes a configuration such as an MPPT control unit of the solar power generation module 111 and a monitoring ECU (not shown) of the auxiliary battery 113, and these configurations operate using the auxiliary battery 113 as a power source. Note that the first power consumption may include power consumed by the auxiliary machine load 130 during solar charging. When the first power consumed by the auxiliary battery 113 is derived, the process proceeds to S302.

### S302

The control unit 114 compares the generated power of the solar panel with the first power consumption of the auxiliary battery 113, and determines whether or not the generated power is larger than the first power consumption. If the generated electric power is larger than the first consumed electric power (S302, Yes), the process proceeds to S303. On the other hand, when the generated electric power is equal to or less than the first consumed electric power (S302, No), the process proceeds to S307.

### S303

The control unit 114 derives the first effective charge amount for the auxiliary battery 113. The first effective charge amount is a charge amount that can be substantially charged to the auxiliary battery 113 among the charge amounts obtained by the power generation of the solar panel. The first effective charge amount may be derived based on a power obtained by subtracting the first power consumption of the auxiliary battery 113 from the generated power of the solar panel. When the first available charge for the auxiliary battery 113 is derived, the process proceeds to S304.

### S304

The control unit 114 compares the first effective charge amount for the auxiliary battery 113 with the limited charge amount (hereinafter referred to as “auxiliary battery limited charge amount”) of the auxiliary battery 113 whose acceptable charge amount is limited. The control unit 114 determines whether or not the first effective charge amount is larger than the auxiliary device limited charge amount based on the result of the comparison. The auxiliary device limited charge amount is as described above. If the first available charge amount is greater than the auxiliary limited charge amount (S304, Yes), the process proceeds to S305. On the other hand, when the first effective charge amount is equal to or less than the auxiliary device limited charge amount (S302, No), the process proceeds to S306.

### S305

The control unit 114 sets the auxiliary device limited charge amount to the auxiliary device chargeable amount because the amount of charge that can be currently stored in the auxiliary battery 113 by solar charging exceeds the auxiliary device limited charge amount of the auxiliary battery 113. When the auxiliary device limited charge amount is set to the auxiliary device chargeable amount, this sub-routine ends and the process returns to S204.

### S306

The control unit 114 sets the first effective charge amount to the auxiliary battery chargeable amount because the charge amount that can be currently stored in the auxiliary battery 113 by solar charging is equal to or less than the auxiliary battery limited charge amount of the auxiliary battery 113. When the first effective charge amount is set to the auxiliary chargeable amount, the sub-routine ends and the process returns to S204.

### S307

The control unit 114 sets the auxiliary chargeable amount to zero because there is a possibility that the amount of electricity stored in the auxiliary battery 113 decreases (is taken out) by performing solar charging. When the auxiliary chargeable capacity is set to zero, the sub-routine ends and the process returns to S204.

### C: Subroutine (FIG. 4)

### S401

The control unit 114 derives the second power consumption related to the auxiliary battery 113. The second power consumption is the power consumed by the auxiliary battery 113 based on the driving of the system necessary for charging the main battery 112 with the generated power of the solar panel. In addition to MPPT control unit of the solar power generation module 111 and the monitoring ECU (not shown) of the auxiliary battery 113, the control unit 114 and the monitoring ECU (not shown) of the main battery 112 are included. These configurations operate using the auxiliary battery 113 as a power source. Note that the second power consumption may include power consumed by the main machine load 120 and the auxiliary machine load 130 during solar charging. When the second power consumed by the auxiliary battery 113 is derived, the process proceeds to S402.

### S402

The control unit 114 compares the generated power of the solar panel with the second power consumption of the auxiliary battery 113, and determines whether or not the generated power is larger than the second power consumption. If the generated electric power is larger than the second consumed electric power (S402, Yes), the process proceeds to S403. On the other hand, when the generated electric power is equal to or less than the second consumed electric power (S402, No), the process proceeds to S407.

### S403

The control unit 114 derives a second effective charge amount for the main battery 112. The second effective charge amount is a charge amount that can be substantially charged to the main battery 112 among the charge amounts obtained by the power generation of the solar panel. The second effective charge amount may be derived based on a power obtained by subtracting the second power consumption of the auxiliary battery 113 from the generated power of the solar panel. When the second available charge for the main battery 112 is derived, the process proceeds to S404.

### S404

The control unit 114 compares the second effective charge amount for the main battery 112 with the limited charge amount (hereinafter referred to as “main engine limited charge amount”) of the main battery 112 whose acceptable charge amount is limited. The control unit 114 determines whether or not the second effective charge amount is larger than the main engine limited charge amount based on the result of the comparison. The charge amount is limited, for example, when the power storage rate (SOC) of the main battery 112 is equal to or higher than a predetermined storage rate, or when the temperature of the main battery 112 is equal to or higher than a predetermined temperature. The main engine limited charge amount is appropriately determined in accordance with the full charge capacity of the main battery 112, the performance and specifications of the vehicle, and the like. If the second available charge amount is greater than the main engine limited charge amount (S404, Yes), the process proceeds to S405. On the other hand, when the second effective charge amount is equal to or less than the main engine limited charge amount (S402, No), the process proceeds to S406.

### S405

The control unit 114 sets the main engine limited charge amount to the main engine chargeable amount because the amount of charge that can be currently stored in the main battery 112 by solar charging exceeds the main engine limited charge amount of the main battery 112. When the main engine limited charge amount is set as the main engine chargeable amount, the sub-routine ends and the process returns to S204.

### S406

The control unit 114 sets the second effective charge amount to the main chargeable amount because the charge amount that can be currently stored in the main battery 112 by solar charging is equal to or less than the main engine limited charge amount of the main battery 112. When the second effective charge amount is set to the main machine chargeable amount, the sub-routine ends and the process returns to S204.

### S407

The control unit 114 sets zero to the chargeable amount of the main machine because there is a possibility that the amount of electricity stored in the auxiliary battery 113 decreases (is taken out) by performing solar charging. When the main chargeable capacity is set to zero, this sub-routine ends and the process returns to S204.

### EXAMPLES

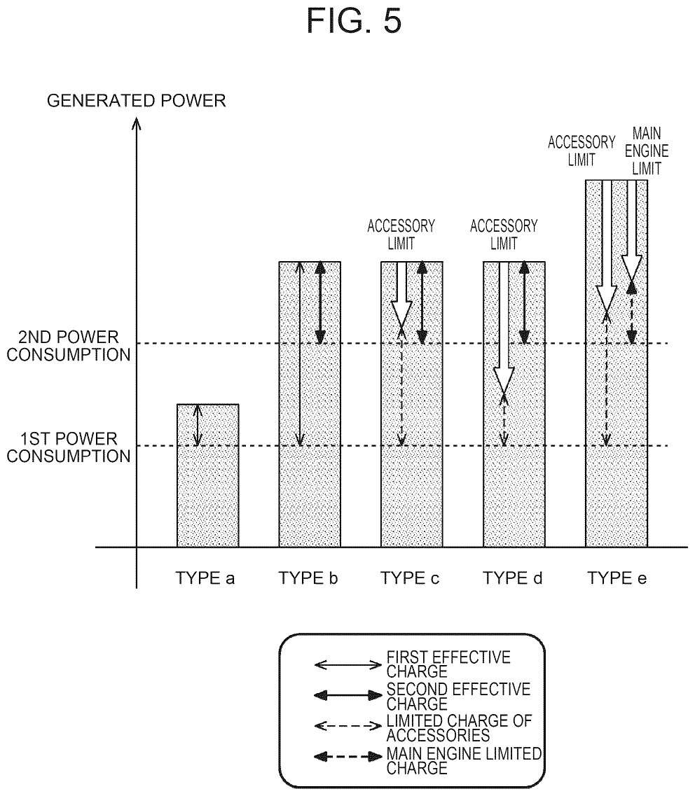

FIG. 5 is an image diagram illustrating a selection example of the auxiliary battery charging mode and the main battery charging mode. In FIG. 5, the vertical axis indicates the generated power of the solar panel, and the shaded rectangle indicates the magnitude of the generated power. In FIG. 5, the solid-line double-arrow indicates the first effective charge amount. The bold double-headed arrow indicates the second effective charge amount. Double-dashed arrows indicate the amount of charge limited by the accessories. Double-dashed bold arrows indicate the main engine limited charge amount. The open single arrow indicates a state in which the charge amount of the main battery 112 and the auxiliary battery 113 is limited.

In the case of the generated power of the type a shown in FIG. 5, the generated power does not reach the second power consumption for the main battery 112, and only the auxiliary battery 113 generates the first effective charge amount. Therefore, in this case, the auxiliary battery charging mode is selected.

In the case of the generated electric power of the type b shown in FIG. 5, the auxiliary battery 113 generates the first effective charge amount and the main battery 112 generates the second effective charge amount. Both the main battery 112 and the auxiliary battery 113 have no charge limit, and the first effective charge amount (=auxiliary chargeable amount) is larger than the second effective charge amount (=main chargeable amount). Therefore, in this case, the auxiliary battery charging mode is selected.

In the case of the type c generated electric power illustrated in FIG. 5, the auxiliary battery 113 generates the first effective charge amount and the main battery 112 generates the second effective charge amount. Here, although the auxiliary battery 113 is limited in the charge amount, the auxiliary limited charge amount (=auxiliary chargeable amount) is larger than the second effective charge amount (=main chargeable amount). Therefore, in this case, the auxiliary battery charging mode is selected. In this case, a part of the generated electric power of the solar panel (the limit of the white piece arrow) is discarded.

In the case of the generated electric power of the type d shown in FIG. 5, the auxiliary battery 113 generates the first effective charge amount and the main battery 112 generates the second effective charge amount. Here, since the auxiliary battery 113 is limited in the charge amount, the auxiliary limited charge amount (=auxiliary chargeable amount) becomes smaller than the second effective charge amount (=main chargeable amount). Therefore, in this case, the main battery charging mode is selected.

In the case of the type e generated electric power illustrated in FIG. 5, the auxiliary battery 113 generates the first effective charge amount and the main battery 112 generates the second effective charge amount. Here, cach of the main battery 112 and the auxiliary battery 113 has a limit of the charge amount, and the auxiliary machine limited charge amount (=auxiliary machine chargeable amount) is larger than the main machine limited charge amount (=main machine chargeable amount). Therefore, in this case, the auxiliary battery charging mode is selected. In this case, a part of the generated electric power of the solar panel (the limit of the white single arrow on the auxiliary machine side) is discarded.

### Operations and Effects

As described above, in the solar charging system 110 according to the embodiment of the present disclosure, when the acceptable charge amount of the auxiliary battery 113 (the first battery) is limited (smaller than that in the normal state), it is determined which case is the larger solar charge amount to the battery between a case where a part of the generated power of the solar panel is discarded and the auxiliary battery 113 is charged, and a case where the generated power of the solar panel is charged to the main battery 112 (the second battery) without discarding the generated power of the solar panel. Accordingly, it is possible to efficiently control the charging using the generated electric power of the solar panel.

Further, in the solar charging system 110 according to the present embodiment, when the charging amount of the auxiliary battery 113 is limited, the auxiliary battery charging mode and the main battery charging mode are switched based on the chargeable amount of each battery. Therefore, it is possible to suppress a decrease in the amount of charge and generation of power to be taken out at the time of switching the charging mode, and it is possible to secure the amount of charge to the battery.

An embodiment of the present disclosure has been described above. The present disclosure can be viewed not only as a solar charging system, but also as a method of controlling battery charging, a program of the method, a computer-readable non-transitory storage medium storing the program, a vehicle equipped with a solar charging system, and the like.

The solar charging system of the present disclosure can be used in a vehicle or the like on which a solar panel is mounted.

What is claimed is:

1. A solar charging system comprising:
a solar panel;
a first battery that is charged with power generated by the solar panel;
a second battery that is different from the first battery; and
a control unit that is provided between the first battery and the second battery and controls charging of the second battery with the generated power, wherein in a case where an amount of charging that the first battery is able to receive is limited, and if an amount by which the second battery is able to be charged is greater than an amount by which the first battery is able to be charged, the control unit performs control to achieve a state where the second battery is able to be charged with the generated power.

2. The solar charging system according to claim 1, wherein the case where the amount of charging that the first battery is able to receive is limited includes at least one of a case where a power accumulation rate of the first battery is equal to or greater than a predetermined power accumulation rate and a case where a temperature of the first battery is equal to or greater than a predetermined temperature.

3. The solar charging system according to claim 1, wherein each of the amount by which the first battery is able to be charged and the amount by which the second battery is able to be charged is set based on the generated power, a limited amount of charging for the first battery for which the amount of charging that is able to be received is limited, first power consumption of the first battery based on driving of the system necessary to charge the first battery with the generated power, and second power consumption of the first battery based on driving of the system necessary to charge the second battery with the generated power.

4. The solar charging system according to claim 3, wherein:
as the amount by which the first battery is able to be charged,
zero is set in a case where the generated power is equal to or less than the first power consumption,
the limited amount of charging is set in a case where the generated power is greater than the first power consumption and a first effective amount of charging derived based on the generated power and the first power consumption is greater than the limited amount of charging, or
the first effective amount of charging is set in a case where the generated power is greater than the first power consumption and the first effective amount of charging is equal to or less than the limited amount of charging; and
as the amount by which the second battery is able to be charged,
zero is set in a case where the generated power is equal to or less than the second power consumption,
the limited amount of charging is set in a case where the generated power is greater than the second power consumption and a second effective amount of charging derived based on the generated power and the second power consumption is greater than the limited amount of charging, or
the second effective amount of charging is set in a case where the generated power is greater than the second power consumption and the second effective amount of charging is equal to or less than the limited amount of charging.

5. The solar charging system according to claim 1, wherein:
the solar charging system is mounted in a vehicle,
the first battery is an auxiliary battery that supplies power to an auxiliary system mounted in the vehicle; and
the second battery is a main battery that supplies power to a main system mounted in the vehicle.
